(19) United States
(12) Patent Application Publication
(10) Pub. No.: US 2008/0148561 A1
(43) Pub. Date: Jun. 26, 2008

(54) METHODS FOR MAKING PRINTED WIRING BOARDS

(75) Inventors: Jaroslaw A. Magera, Palatine, IL (US); Bruce C. Deemer, Crystal Lake, IL (US); Gregory J. Dunn, Arlington Heights, IL (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/615,932

(22) Filed: Dec. 22, 2006

(51) Int. Cl. H01R 43/00

(52) U.S. Cl. 29/852

(57) ABSTRACT

A method of making a multilayer, printed wiring board may include pre-drilling a prepreg sheet to form a hole free of glass fibers. The hole has a first diameter. The method includes laminating the pre-drilled prepreg sheet between a copper foil and a substrate and allowing the hole to fill with resin from the prepreg sheet, patterning the copper foil to create an opening in a location associated with the resin-filled hole, drilling a via hole in the resin-filled hole, and metallizing the copper foil and the via hole. The via hole has a second diameter smaller than the first diameter.

### TECHNICAL FIELD

The present invention is directed to printed wiring boards. More particularly, the present invention is directed to methods for making multilayer, printed circuit boards.

### BACKGROUND

Some conventional printed circuit boards are produced by a process that includes direct plate metallization. Blind vias improperly formed during the process sometimes cause electrical opens in the boards.

The geometry of laser-drilled vias in glass-reinforced epoxy circuit board materials such as FR-4 is not compatible with direct plate metallization. The advance of copper into the via during the metallization process is disrupted or blocked by glass fiber stubs in the barrel and/or copper foil overhang at the rim. The stubs result from incomplete laser ablation of the woven glass fabric in the laminate, since the epoxy resin ablates more readily. The overhang results from excessive epoxy ablation where glass content is low and the laser power and dwell time are thus too high. This defect is known as “barreling.”

Both of these problems are exacerbated by the desmear process typically performed after drilling and before plating, which attacks resin but not glass. Thus, the desmear process enhances the barreling and exposes more glass. The resulting vias are irregular and varied, and a uniform copper advance into the via is prevented. Accordingly, thin plating, plating folds, irregular via profiles, and/or field failures occur.

One conventional process for making printed circuit boards is described in U.S. Pat. No. 5,263,243. The disclosed process includes drilling prepreg prior to lamination. The process further includes conductive paste plugs for vertical interconnects. Such conductive paste plug processes are expensive and present their own reliability problems.

It may be desirable to provide a method for making multilayer, printed wiring boards including a low-cost and simple process for shaping blind vias to facilitate uniform direct plate metallization. It may be desirable to provide a method that accounts for some degree of mis-registration during the production process and/or prevents thin plating, plating folds, irregular via profiles, and/or field failures.

### SUMMARY OF THE INVENTION

According to various aspects of the disclosure, a method of making a multilayer, printed wiring board may include pre-drilling a prepreg sheet to form a hole free of glass fibers. The hole has a first diameter. The method includes laminating the pre-drilled prepreg sheet between a copper foil and a substrate and allowing the hole to fill with resin from the prepreg sheet, patterning the copper foil to create an opening in a location associated with the resin-filled hole, drilling a via hole in the resin-filled hole, and metallizing the copper foil and the via hole. The via hole has a second diameter smaller than the first diameter.

In accordance with some aspects of the disclosure, a method of making a multilayer, printed wiring board may include removing glass fibers from a region of a prepreg sheet to form a region free of glass fibers. The region has a first diameter. The method includes laminating the prepreg sheet between a copper foil and a substrate and allowing the region to fill with resin from the prepreg sheet, patterning the copper foil to create an opening in a location associated with the resin-filled hole, drilling a via hole in the resin-filled region, and metallizing the copper foil and the via holes. The via hole has a second diameter smaller than the first diameter.

### BRIEF DESCRIPTION OF THE DRAWINGS

FIG. 1 is a partial and diagrammatic view explaining a method of making a printed wiring board in accordance with exemplary aspects of the disclosure;

FIG. 2 is a partial and diagrammatic view explaining a method of making a printed wiring board in accordance with exemplary aspects of the disclosure;

FIG. 3 is a partial and diagrammatic view explaining a method of making a printed wiring board in accordance with exemplary aspects of the disclosure;

FIG. 4 is a partial and diagrammatic view explaining a method of making a printed wiring board in accordance with exemplary aspects of the disclosure; and

FIG. 5 is a partial and diagrammatic view explaining a method of making a printed wiring board in accordance with exemplary aspects of the disclosure.

### DETAILED DESCRIPTION

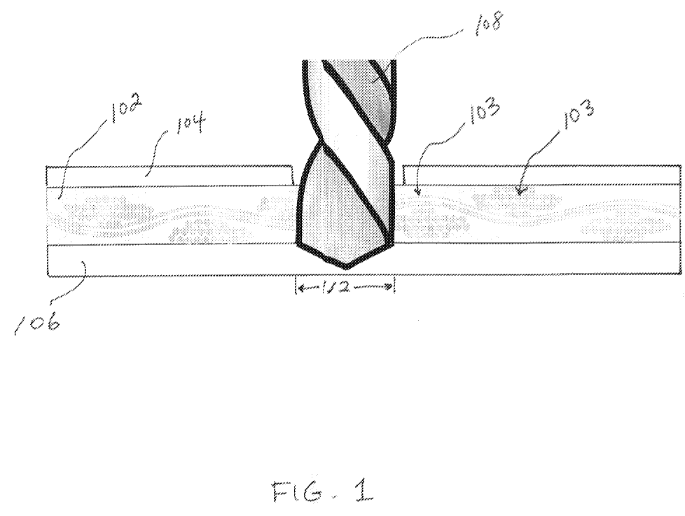

An exemplary method of making a printed wiring board is described with respect to the illustrations of FIGS. 1-5. The printed wiring board produced via the exemplary method may comprise, for example, a multilayer printed circuit board.

According to various aspects of the disclosure, a prepreg sheet 102 is prepared and sandwiched between an entry material 104 and a backer material 106 for drilling, as shown in FIG. 1. In some aspects, the prepreg sheet 102 may comprise a resin with embedded glass fibers 103 such as, for example, a B-stage epoxy glass. The prepreg sheet 102 may have a thickness of about 0.025 to about 0.250 mm. The resin may be epoxy, polyimide, phenol, Teflon, or the like. The entry material 104 and the backer material 106 may comprise a C-stage laminate of the same resin type as the prepreg sheet 102 so as to prevent contamination of the prepreg sheet 102 during drilling.

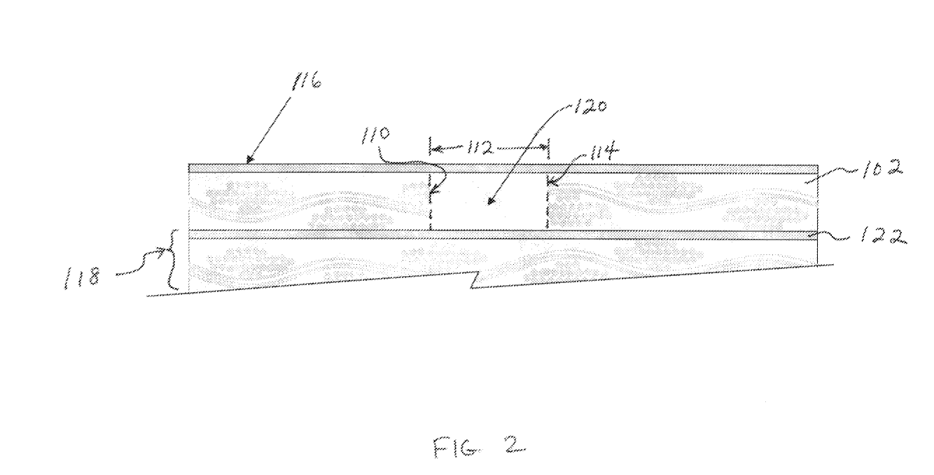

The prepreg sheet 102 is drilled with a drill bit 108 configured to form a bore 110 (FIG. 2) having a first diameter 112. The entry material 104 may be pre-drilled with oversized holes to reduce the amount of material the drill bit 108 must cut through. The drill bit 108 goes through the prepreg sheet 102, thus forming a drilled through hole 114 (FIG. 2) with the first diameter 112 in the prepreg sheet 102. According to various aspects, the drilled through hole 114 may have a diameter of about 0.1 to about 0.5 mm.

It should be appreciated that more than one through hole may be drilled in the prepreg sheet 102. The through hole(s) may be bored in prescribed positions of the prepreg sheet 102 (positions corresponding to the positions where connecting pads (not shown) of a substrate 43 are formed)

The drill speeds for drilling the B-stage prepreg sheet 102 differ significantly from those typically used to drill conventional C-stage printed circuit board laminate. The drill speeds typically used with C-stage laminate would melt the prepreg sheet 102, fouling the bit and preventing consistent drilling. The plunge and retract rates of the drill bit should be set at a maximum and plunge depth at a minimum to reduce the bit-to-prepreg contact time. Cut-back drill bits may also be used to reduce the bit-to-prepreg contact area.

It should be appreciated that the drill bit can be changed frequently to reduce the number of hits per bit. The appearance of the bit can be observed to determine if the bit becomes coated with resin, and the quality of the drilled holes can be observed so that the user can change the bit when appropriate. The used drill bits can be cleaned and reused.

The entry material 104 and backer material 106 are removed, and the drilled prepreg sheet 102 is sandwiched between a copper foil 116 and a substrate 118. According to various aspects, the substrate 118 may comprise a single sheet or a multilayer stack of laminated sheets. The sheet or stack may comprise, for example, one or more C-stage laminates of the same resin type as the prepreg sheet 102 or a different resin-type, and one or more copper foils or patterned copper foils.

Referring now to FIG. 2, the prepreg sheet 102 is laminated between the copper foil 116 and the substrate 118. The laminating process may include applying heat and pressure to the foil 116, the prepreg sheet 102, and the substrate 118 using a pressure device. As the prepreg sheet 102 is laminated, the heat and pressure cause the resin to flow; some of the resin flows out of the prepreg sheet 102 into the drilled hole 114, thereby defining a glass-fiber-free, resin-filled region 120 of the prepreg sheet 102 corresponding to the diameter 112 of the drilled hole 114. A surface layer 122 of the substrate 118 facing the prepreg sheet 102 may comprise, for example, a copper foil. The copper foil 116 and/or a copper foil of the surface layer 122 may have a thickness of about 5 to about 40 μm.

According to various aspects, the substrate 118, the prepreg sheet 102, and the copper foil 116 may be integrally bonded by heating the resulting structure at a temperature of about 150° to about 250° C. when a resin such as epoxy, polyimide, phenol, or the like is used or at a temperature of about 400° C. when Teflon is used for the resin, while pressurizing the structure to a pressure of about 5 to about 40 kg/cm², using a heat-pressure device. A heat-pressure device such as a hydraulic pressing machine, a hydraulic vacuum pressing machine or autoclave or the like may be used.

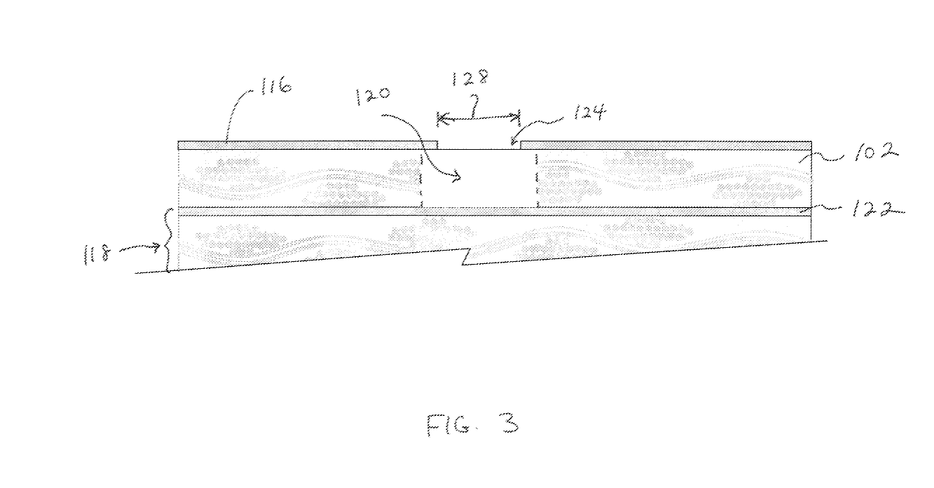

Next, as shown in FIG. 3, the copper foil 116 is patterned to create an opening 124 through the copper foil 116 that exposes a portion of the region 120 of the cured prepreg sheet 102 free of glass fibers. The opening 124 has a second diameter 128 less than the first diameter 112 of the drilled hole 114. According to various aspects, the opening 124 may have a diameter of about 0.025 to about 0.250 mm. The process for patterning the copper foil 116 may comprise, for example, an etching process or a laser drilling process that may be concurrent with the via hole forming process described next.

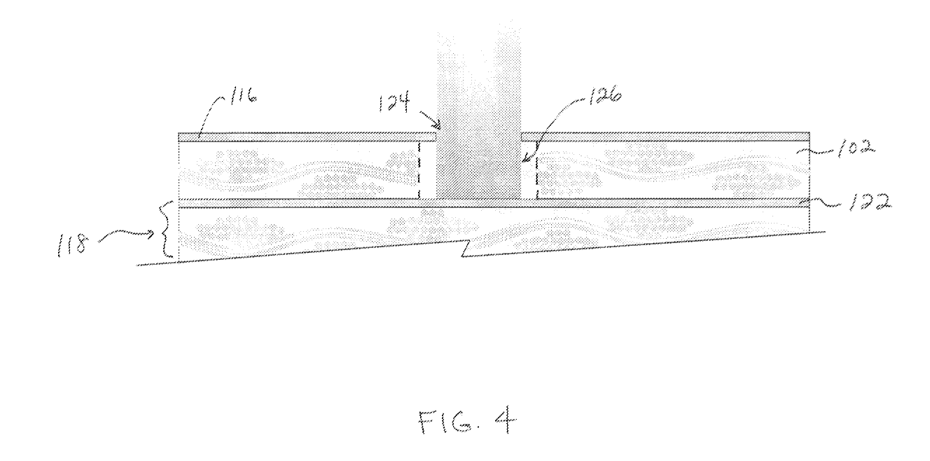

As shown in FIG. 4, a via hole 126 is then drilled in the glass-free region 120 of the cured prepreg sheet 102. The via hole 126 has a diameter substantially equal to the second diameter 128 and less than the first diameter 112 of the drilled hole 114. According to some aspects, the via hole 126 may comprise a microvia hole. The via hole 126 may extend completely through the cured prepreg sheet 101, from the copper foil 116 to the surface layer 122 of the substrate 118. The via hole 126 may be drilled, for example, by laser drilling. When a laser that ablates the resin much more rapidly than copper, such as a carbon dioxide laser, is used, the diameter of the laser beam may be larger than the diameter 128 of the opening 124, the opening 124 in the copper foil acts as a mask, and the via hole 126 and opening 124 are inherently self-aligned. Alternatively, when a laser that is effective at ablating both copper and resin, such as an ultraviolet laser, is used, the patterning step of FIG. 3 is essentially concurrent with the via hole forming step, and the opening 124 and via hole 126 are formed in a single step by the same laser, and are inherently self-aligned. Other laser drilling options known in the art, such as a combined ultraviolet/carbon dioxide laser system, may also be used. In all cases, the larger first diameter 112 allows for some degree of mis-registration of the via hole 126 without affecting the integrity of the via hole 126, provided the via hole 126 still falls within the glass-free region 120. The exposed resin at the opening 124 is removed by the irradiation of laser beams to thereby form the via hole 126 and expose the surface layer 122 of the substrate 118.

As is known in the art, the necessary power of a laser used for drilling through resin is less than that of a laser used for drilling through glass. Since the laser drills through resin only, the wavelength of the laser may be adjusted to a setting ideal for drilling through resin without the need to drill through glass fibers, thus providing a well-defined and consistent via hole 126.

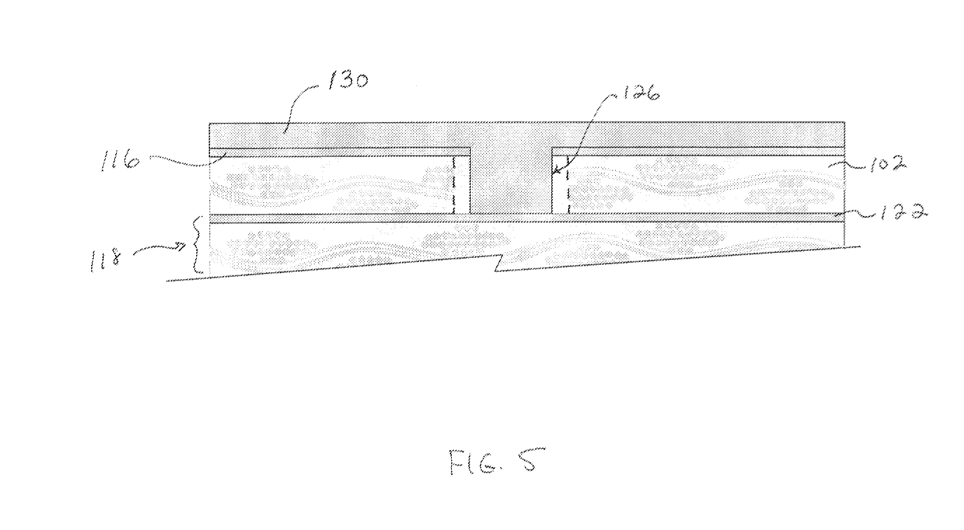

Referring now to FIG. 5, the assembly is metallized by applying a metal plating 130, such as, for example, copper plating, to the whole surface of the assembly including the copper foil 116, an inner wall of the via hole 126, and the exposed surface layer 122 of the substrate 118 to thus give a copper-plated via hole 126. The metallization process may comprise direct plate metallization, wherein a conductive coating, such as, for example, graphite, is deposited on a target region to enable, for example, copper electroplating. The copper migrates from the copper foil 116 to the surface layer 122 of the substrate 118 at the bottom of the via hole 126.

Thereafter, the metal plating layer 130, the copper foil 116, and the surface layer 122 of the substrate 118 may be patterned to thereby result in a completed multilayer printed wiring board or a sub-assembly thereof. The exemplary method of the disclosure may include a desmear process for removing resin from the copper surfaces before the metallization process.

It should be appreciated that the process of the disclosure may be used to produce any desired number of via holes in a prepreg sheet. The prepreg sheet may be combined with other laminates or substrate stacks to produce any desired printed circuit board configuration.

It will be apparent to those skilled in the art that various modifications and variations can be made in the devices and methods of the present disclosure without departing from the scope of the invention. Other embodiments of the invention will be apparent to those skilled in the art from consideration of the specification and practice of the invention disclosed herein. It is intended that the specification and examples be considered as exemplary only.

What is claimed is:

1. A method of making a multilayer, printed wiring board, comprising:
drilling a prepreg sheet to form a hole free of glass fibers, the hole having a first diameter;
laminating the drilled prepreg sheet between a copper foil and a substrate and allowing the hole to fill with resin from the prepreg sheet;
patterning the copper foil to create an opening in a location associated with the resin-filled hole;
drilling a via hole in the resin-filled hole, the via hole having a second diameter smaller than the first diameter; and
metallizing the copper foil and the via hole.

2. The method of claim 1, wherein the via hole is drilled by laser drilling.

3. The method of claim 2, wherein the laser drilling is performed with one of an ultraviolet laser and a carbon dioxide laser.

4. The method of claim 1, wherein the patterning comprises one of an etching process and a laser drilling process.

5. The method of claim 1, wherein the metallizing comprises a direct plate metallization process.

6. The method of claim 1, wherein the drilling a prepreg sheet further comprises sandwiching the prepreg sheet between an entry material and a backer material.

7. The method of claim 6, wherein the entry material and the backer material comprise a laminate of a same resin type as the prepreg.

8. The method of claim 1, wherein the via holes comprise microvia holes.

9. The method of claim 1, further comprising desmearing resin from copper surfaces before the metallizing.

10. A multilayer, printed wiring board produced by the method of claim 1.

11. A method of making a multilayer, printed wiring board, comprising:
removing glass fibers from a region of a prepreg sheet to form a region free of glass fibers, the region having a first diameter;
laminating the prepreg sheet between a copper foil and a substrate and allowing the region to fill with resin from the prepreg sheet;
patterning the copper foil to create an opening in a location associated with the resin-filled hole;
drilling a via hole in the resin-filled region, the via hole having a second diameter smaller than the first diameter; and
metallizing the copper foil and the via hole.

12. The method of claim 11, wherein the via hole is drilled by laser drilling.

13. The method of claim 12, wherein the laser drilling is performed with one of an ultraviolet laser and a carbon dioxide laser.

14. The method of claim 11, wherein the patterning comprises one of an etching process and a laser drilling process.

15. The method of claim 11, wherein the metallizing comprises a direct plate metallization process.

16. The method of claim 11, wherein the removing glass fibers comprises:
sandwiching the prepreg sheet between an entry material and a backer; and
drilling the region.

17. The method of claim 16, wherein the entry material and the backer comprise a laminate of a same resin type as the prepreg.

18. The method of claim 11, wherein the via holes comprise microvia holes.

19. The method of claim 11, further comprising desmearing resin from copper surfaces before the metallizing.

20. A multilayer, printed wiring board produced by the method of claim 11.
